(19) United States
(12) Patent Application Publication
(10) Pub. No.: US 2010/0227660 A1
(43) Pub. Date: Sep. 9, 2010

(54) Horse video poker apparatus

(76) Inventor: Yoshio Nakano, Long Beach, CA (US)

Correspondence Address: Quinn Emanuel Urquhart Oliver & Hedges, LLP;Koda/Androlia, 865 S. Figueroa Street, 10th Floor, Los Angeles, CA, 90017, US

(21) Appl. No.: 12/381,179

(22) Filed: Mar. 9, 2009

(51) Int. Cl. A63F 9/24; A63F 13/00

(52) U.S. Cl. 463/13; 463/30

(57) ABSTRACT

A method and apparatus for playing a plurality of different video poker games using a microprocessor, a player input device and a display device including the ordered steps of displaying a plurality of different poker games on the display device, selecting one of the plurality of different poker games by means of the player input device and playing the selected one of the plurality of different poker games using the display device and player input device.

### CROSS REFERENCE RELATED APPLICATIONS

None

### GOVERNMENT CONTACTS

None

### BACKGROUND OF THE INVENTION

1. Field of Invention

This invention relates to methods and apparatuses for playing computer video casino games and more particularly to video poker games.

2. Prior Art

In the prior art there exists a number of vide poker apparatuses and method. Typical examples of such prior art devices are listed in the Information Disclosure Statement. While these prior art devices relate to video poker games, all of them have substantially the same deficiency. In particular, each one of these prior art apparatuses is only capable of playing a single type of poker, typically draw poker.

### SUMMARY OF THE INVENTION

Accordingly, it is a general object of the present invention to provide a video poker apparatus capable of allowing a user to play more than one type of poker.

It is another object of the present invention to provide a video poker apparatus capable of playing Hold-em, Omaha Eight or better, Razz, Stud and Eight or better Stud.

The above mentioned objects of the present invention are accomplished by a unique method and apparatus for playing a plurality of different vide poker games using at least a microprocessor, a player input device and a display. The method includes the ordered steps of displaying a plurality of different poker games on the display, selecting one of the plurality of different poker games by means of the player input device and playing the selected one of the plurality of different poker games using the display and player input device.

In addition, if this apparatus is utilized in a casino, the apparatus can be provided with means for accepting user payment to play the machine and for pay-out to a user. Still further, such a machine or apparatus for a casino could include a sound generator or maker which generates excitement sounds when a player wins and/or sounds to attract players.

### BRIEF DESCRIPTION OF THE DRAWINGS

The above mentioned features and objects of the present invention will become more apparent with reference to the following description taken in conjunction of the accompanying drawings wherein:

FIG. 1. is a block diagram of the basic hardware elements of the present invention; and

FIGS. 2 through 31 illustrate the information displayed to a user on the display means and when taken together illustrate a flow diagram of the operation of the apparatus and the process of the method.

### DETAILED DESCRIPTION OF THE INVENTION

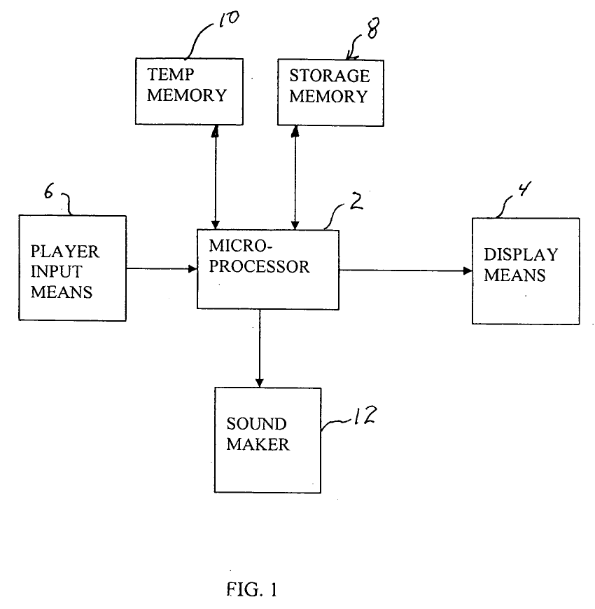

Referring to FIG. 1, shown therein is a block diagram of the basic hardware comprising the apparatus of the present invention. In particular, the video poker apparatus comprises a microprocessor 2 which is connected to a display means 4, player input means 6, storage memory 8, temporary (temp) memory 10 and a sound or noise generator 12. The microprocessor 2 controls the operation of the apparatus in response to user input from the player input means 6 and displays the various screens on the display means 4. In addition the microprocessor 2 works together with the storage memory 8 which generally contains the software or programming to control the entire operation of the apparatus through the microprocessor 2. The temporary memory 10 can be utilized to store additional items which the microprocessor may not want to store in the storage means 8 such as how much money the user has entered into the apparatus, how much money the user has remaining to utilize for playing of the apparatus, pay-outs, etc. In addition the microprocessor 2 is connected to the sound generator 12 to cause the sound generator to generate sounds when the user wins or to attract users to the apparatus.

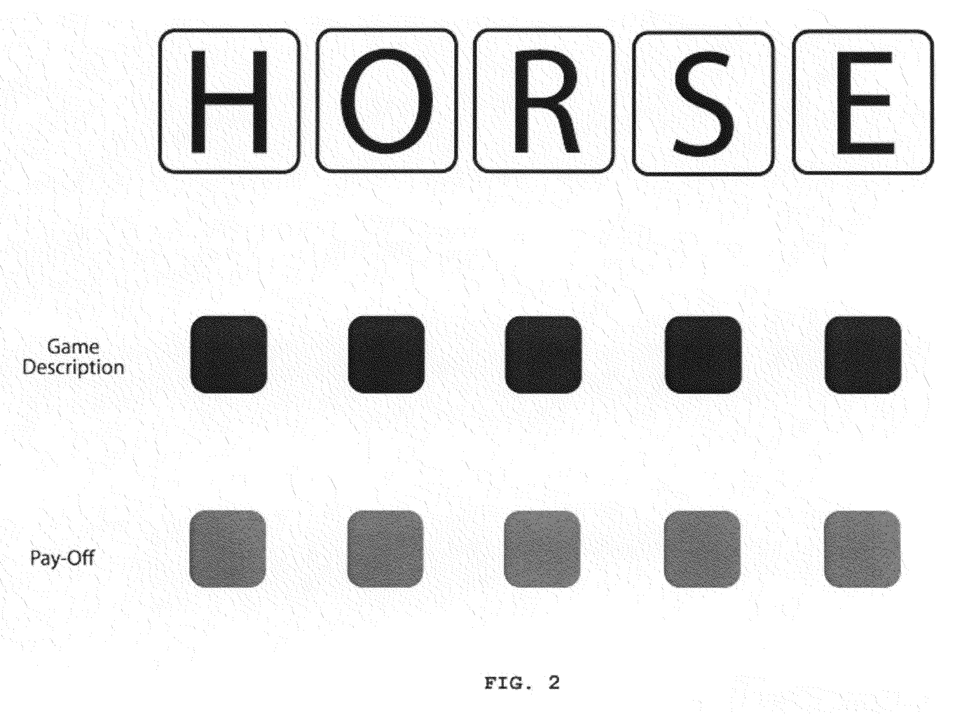

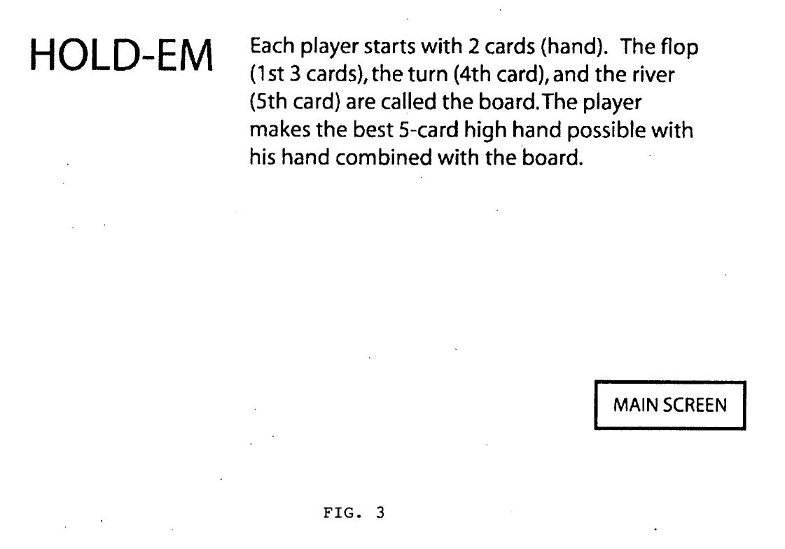

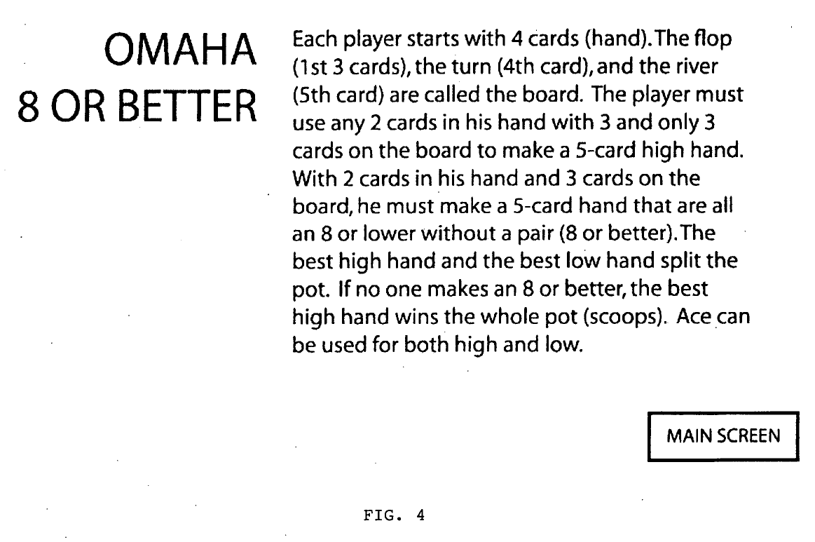

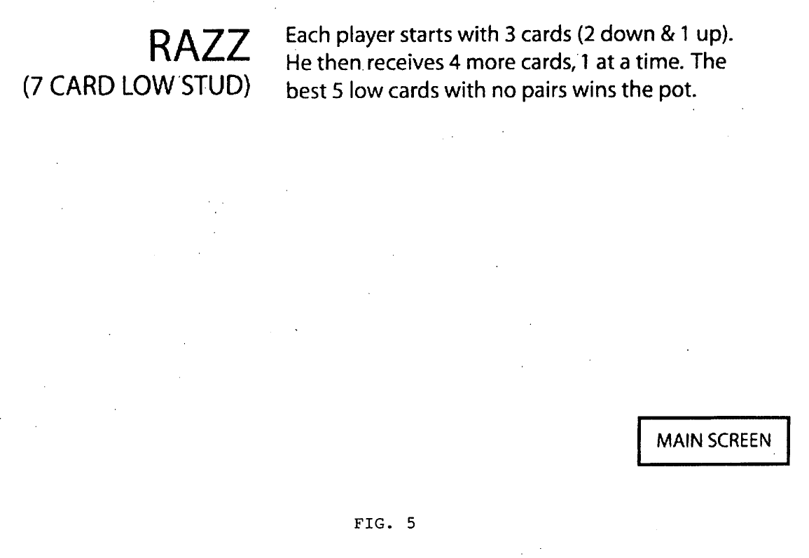

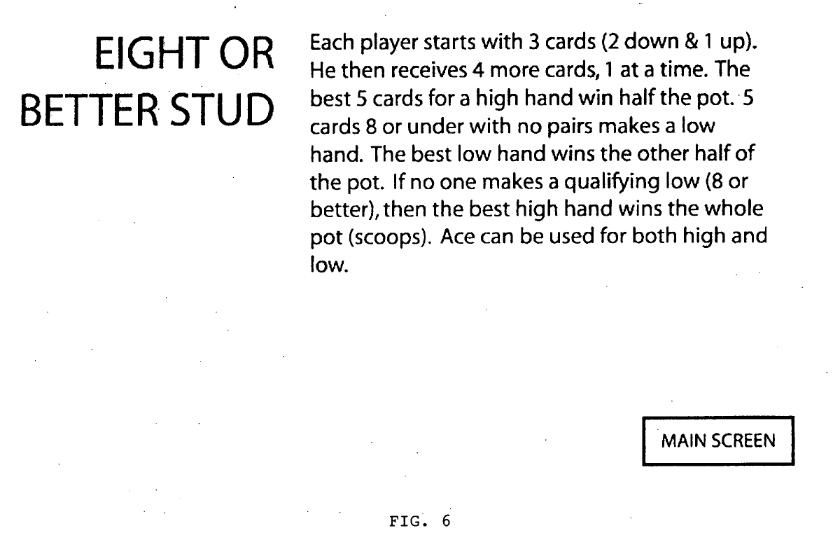

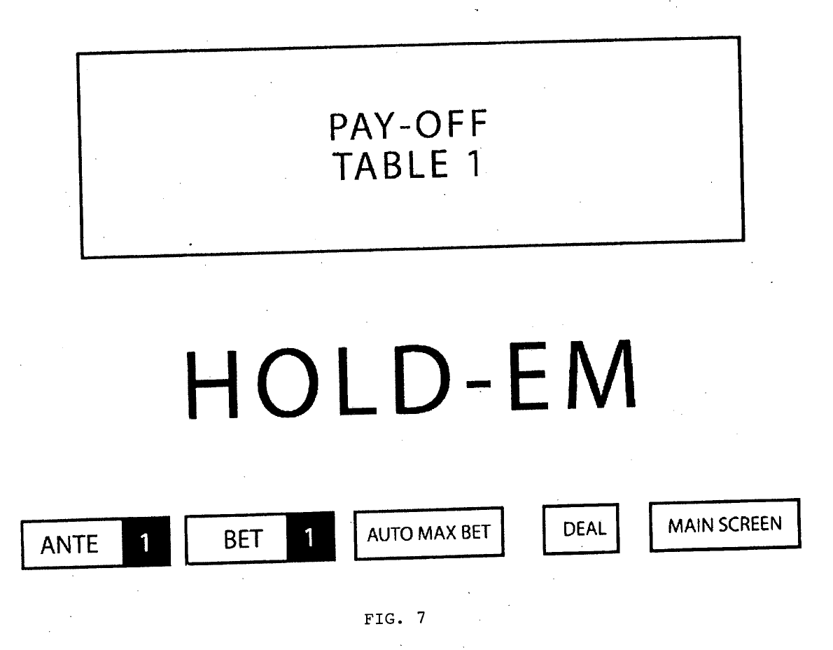

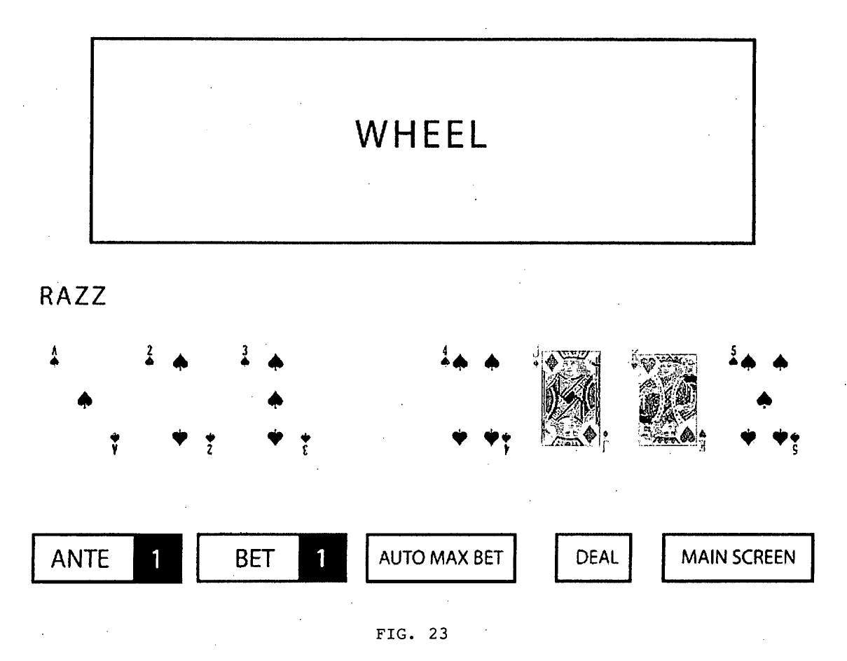

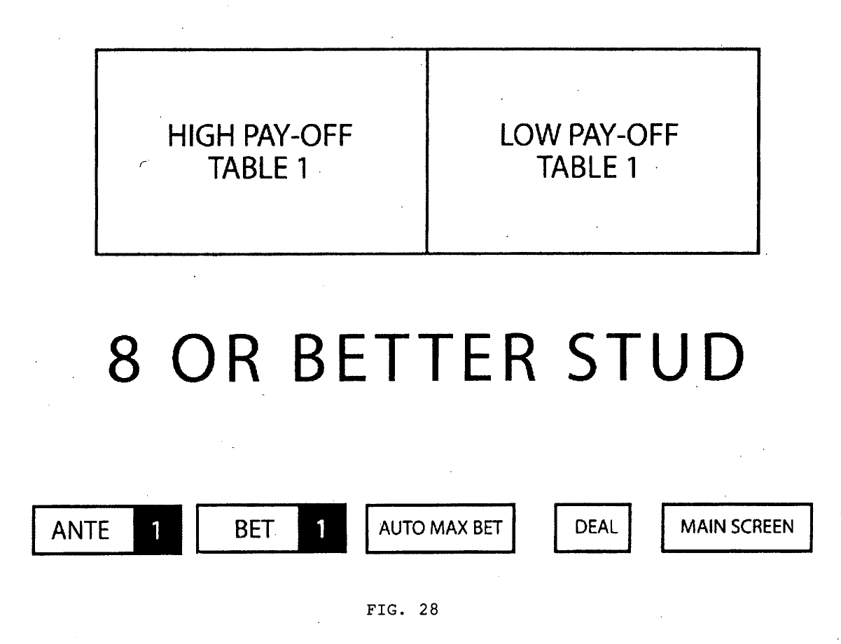

Referring to the FIGS. 2 through 31, shown in FIG. 2 is the main screen which appears on the display means 4 when a user approaches the apparatus. On the main screen the icons H, O, R, S, E represent the plurality of poker games which can be played on the video poker machine and by selecting the pay-off icon under each one of the H, O, R, S, E, icons, the player can receive pay-off charts for each of the particular games. The pay off charts are based upon the usual odds in each of the poker games less a profit for the house. In addition, by pressing the game description icon under each of the icons H, O, R, S, E, the player can receive a description for each one of the poker games. In the FIGS. 2 through 7 are examples of the screen display on the display means 4 for each one of the explanations of the five different poker games which are played on the machine, namely Hold-em, Omaha Eight or better, Razz, Stud and Eight or better Stud.

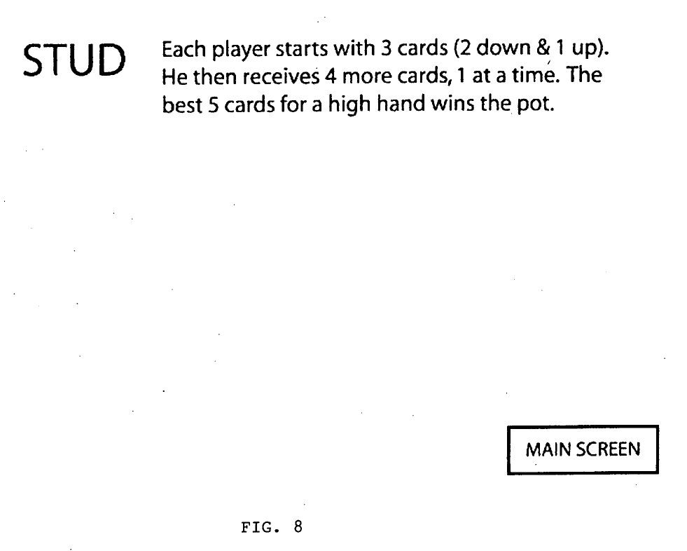

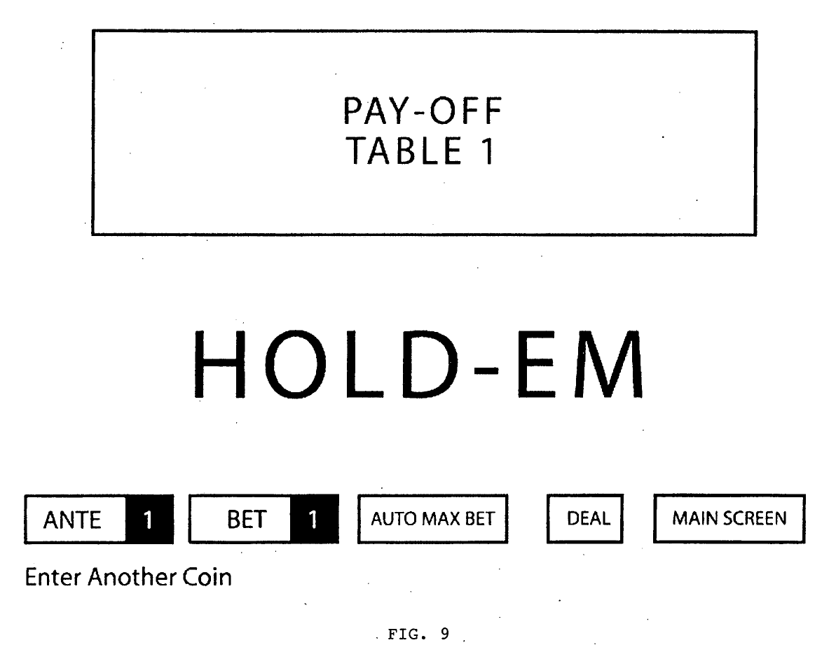

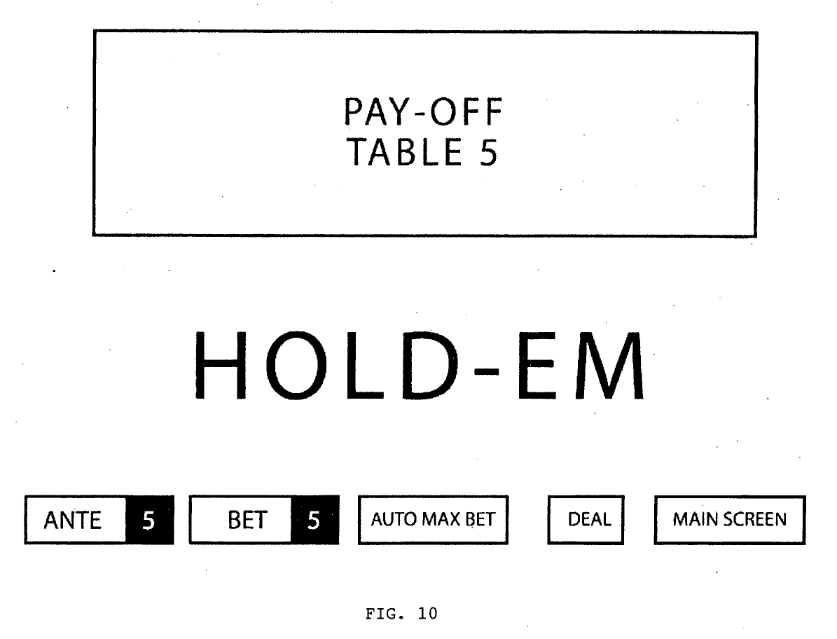

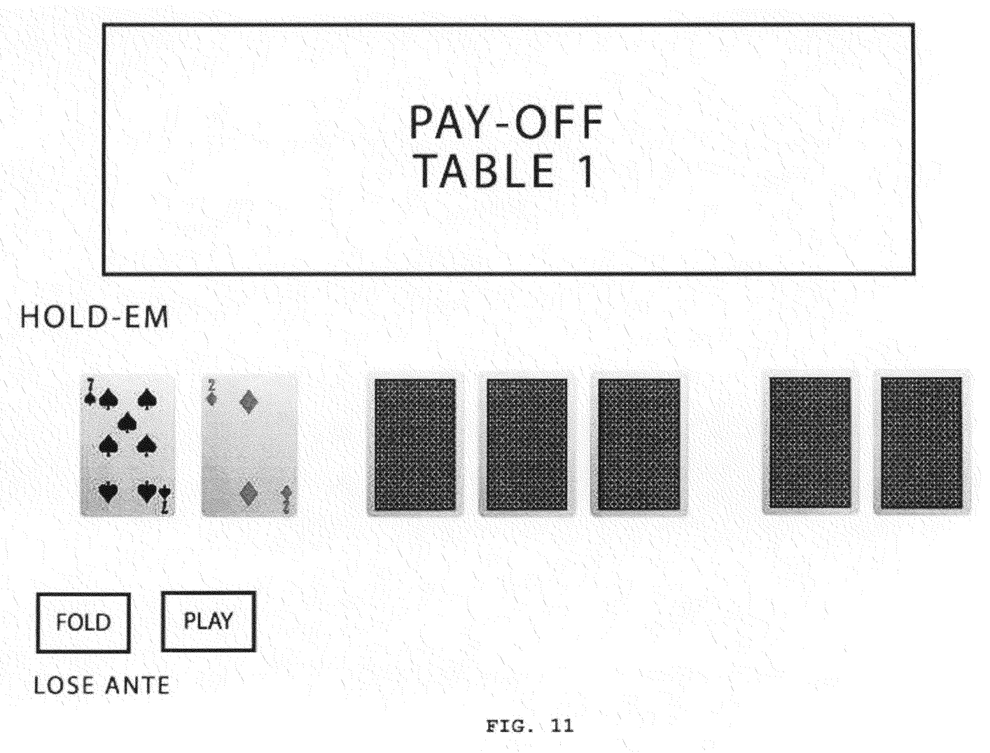

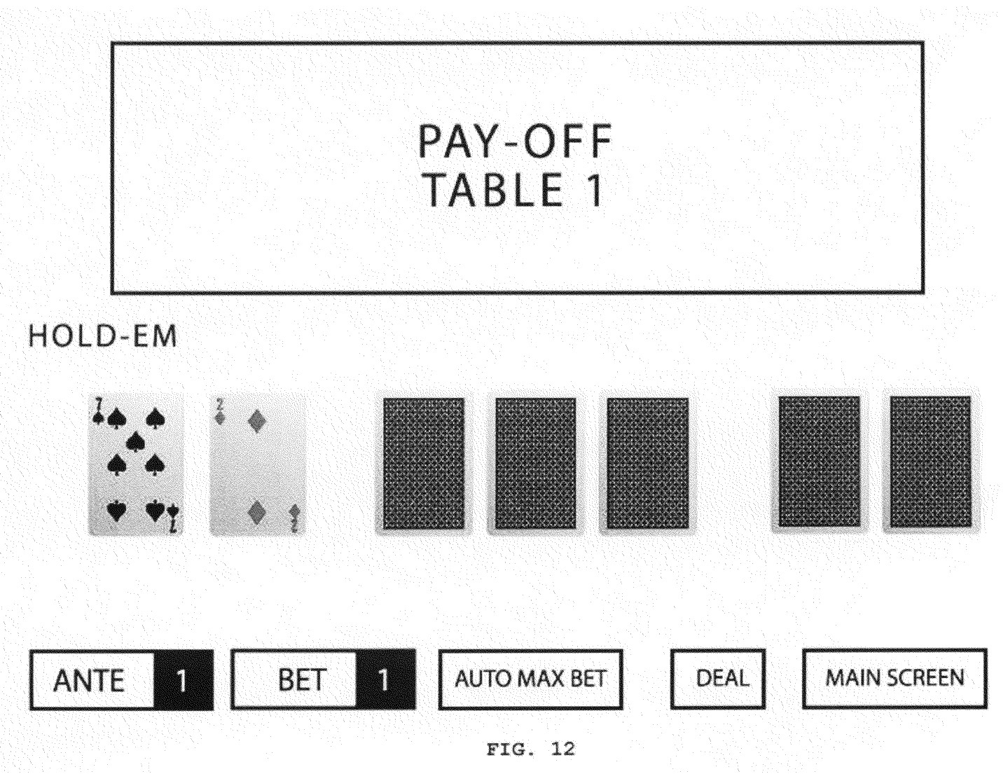

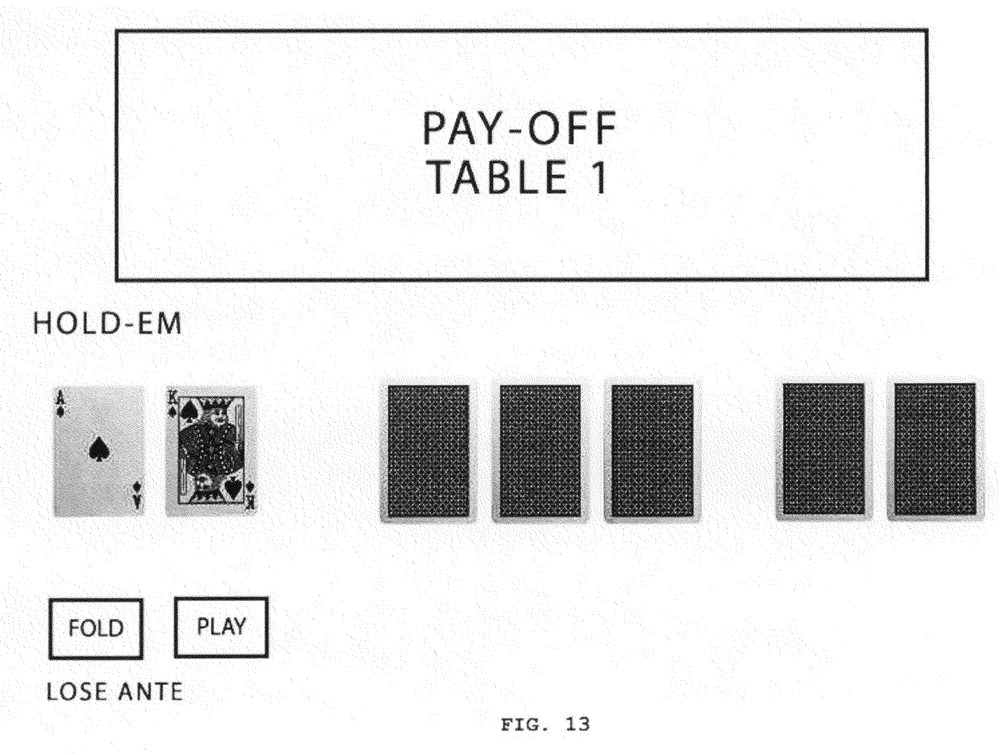

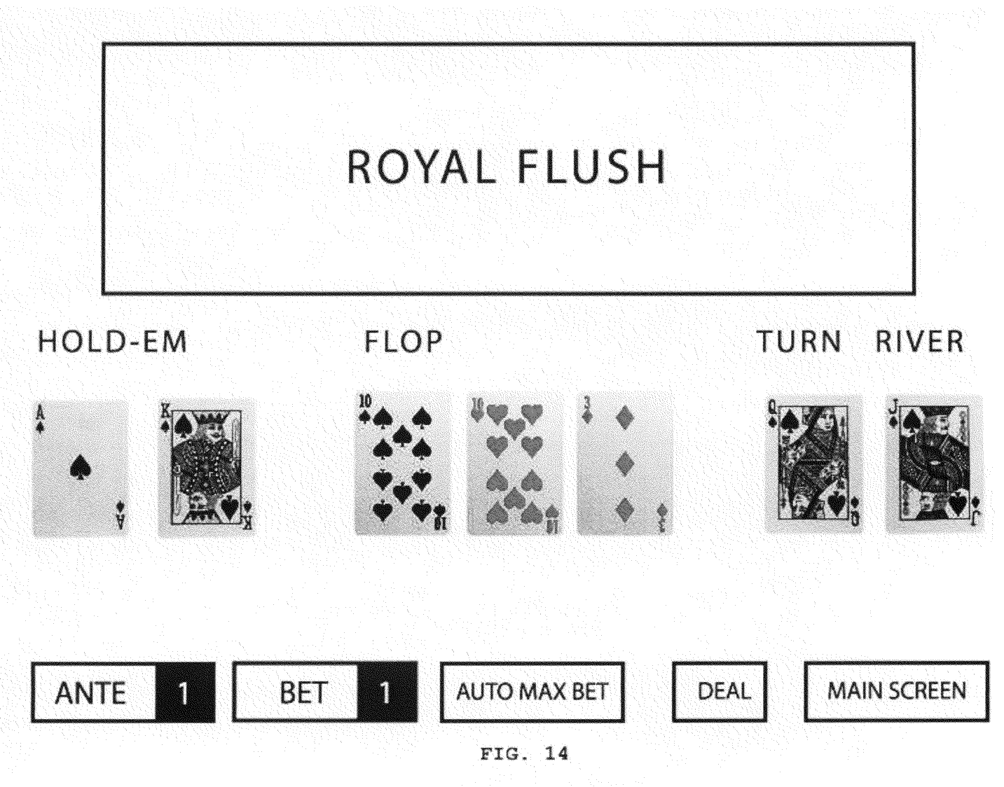

In operation, if we assume that a player after looking at the game descriptions and the pay-off tables, first selects the H icon from the main screen icon of FIG. 2, this icon represents the poker game called Hold-em and the screen which appears in FIG. 8 will appear on the display means 4. At the screen of FIG. 8 the player ante's or bets. If the ante or bet exceeds what the player has stored in the machine, the display automatically shifts to that shown in FIG. 9 to remind the player to add more money. If the player selects the auto max bet option, the apparatus will automatically play up to a maximum of 10 coins based upon the players selection as is shown in FIG. 10. After making the ante or the bet, the player selects the deal icon and the first two cards are displayed as is shown in the screen of FIG. 11. At this point the player can decide to fold or continue to play. If the player selects fold, he loses his ante and the game ends at FIG. 12. At this point the player can again ante and the game proceeds to deal a new two cards as is shown in FIG. 13 and again the player can select fold or play. If the player selects play, the three card flop is dealt, followed by two more cards as is shown in FIG. 14. Also shown in FIG. 14 is a winning hand which is a royal flush and the pay-off flashes on the pay-off table and the hand is paid for the total of the ante and the bet according to the pay-off table. The ante and bet, deal and main screen options appear at the end of every hand. Pressing the main screen returns back to the main screen of FIG. 2 or the player could press ante and continue to play by pressing deal.

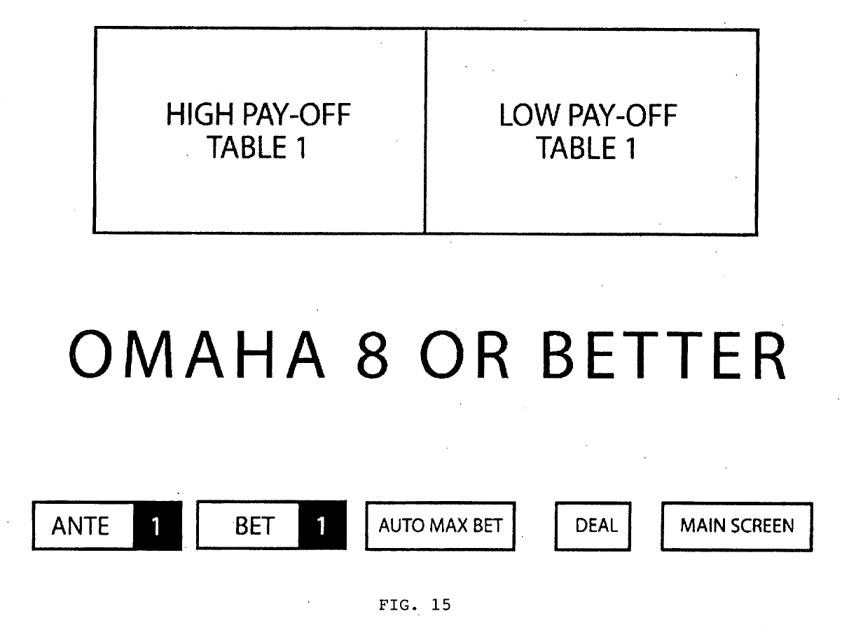

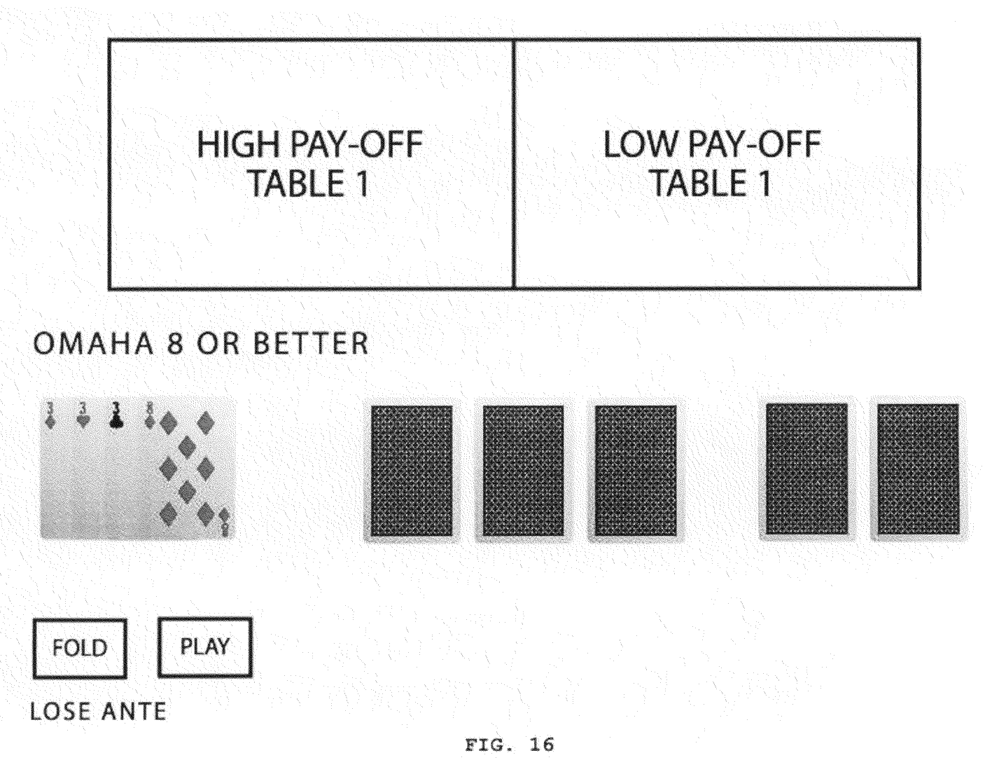

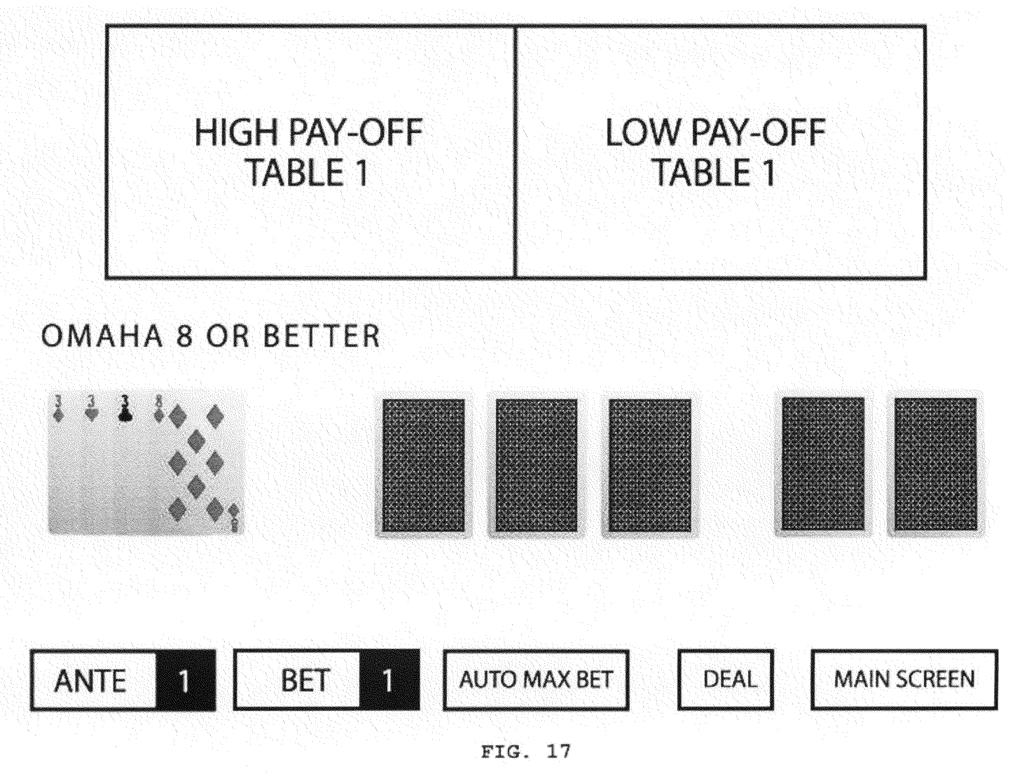

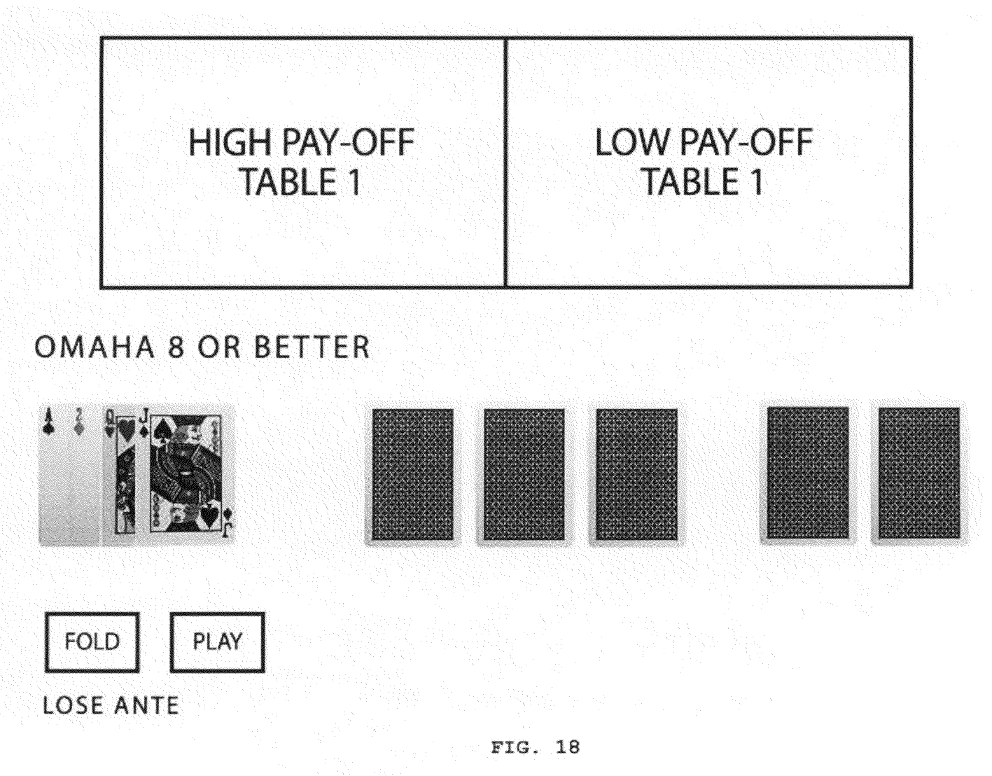

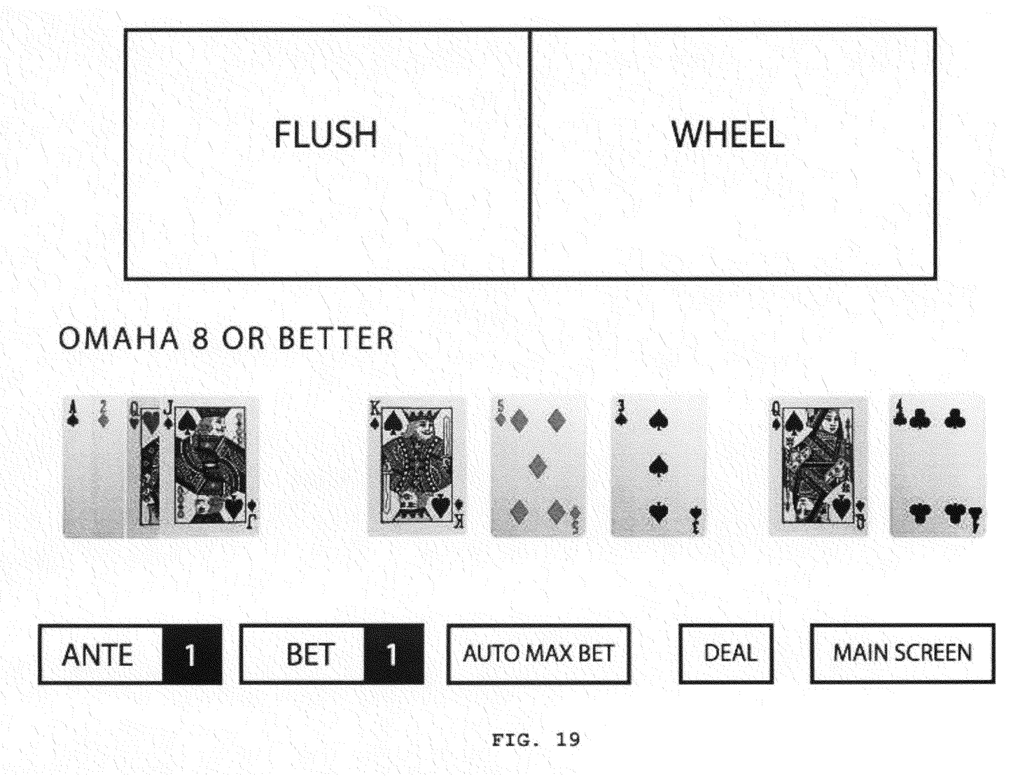

If after returning to the main screen of FIG. 2, the player decides to play Omaha Eight or better, the player selects the O and the screen of FIG. 15 appears on the display 4. At this screen the player may select the ante or bet which allows the player to enter an ante and a bet during the playing of the game. If the player does not have sufficient money or coins in the machine or apparatus, similarly to the screen of FIG. 9, the apparatus will prompt the player to enter another coin. The auto max bet functions similarly to that shown in conjunction with FIG. 10 in Hold-em if selected by the player. If the player selects deal, the four card Omaha hand appears along with the fold and play options as is shown in the display of FIG. 16. If the player selects the fold option, the game ends and the player loses the ante and the player is then at the point shown in FIG. 17. At this point the player ante's again and presses deal which brings the player to the display of FIG. 18. If the player selects the play option, the three card flop is dealt followed by two more cards, one at a time as is shown in FIG. 19 and the winning hand appears and is paid for the total of the ante and the bet according to the pay-off tables. If there is no winner or qualifier for either the high and/or the low, NO HIGH and/or NO LOW would appear on the display. At the end of each hand the ante, bet, deal and main screen options appear. If the player no longer desires to play Omaha Eight or better, the player would select main screen and select another poker game to play such as Razz.

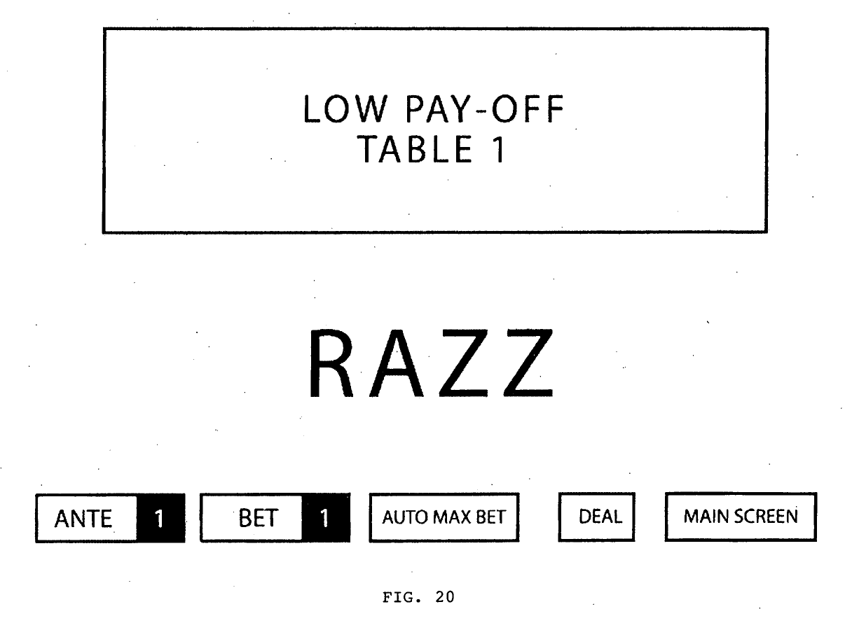

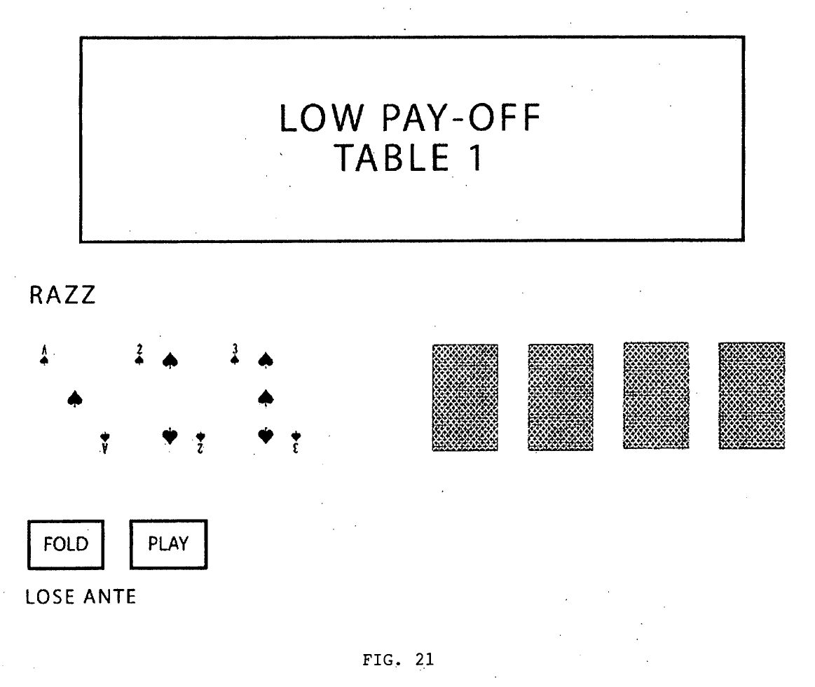

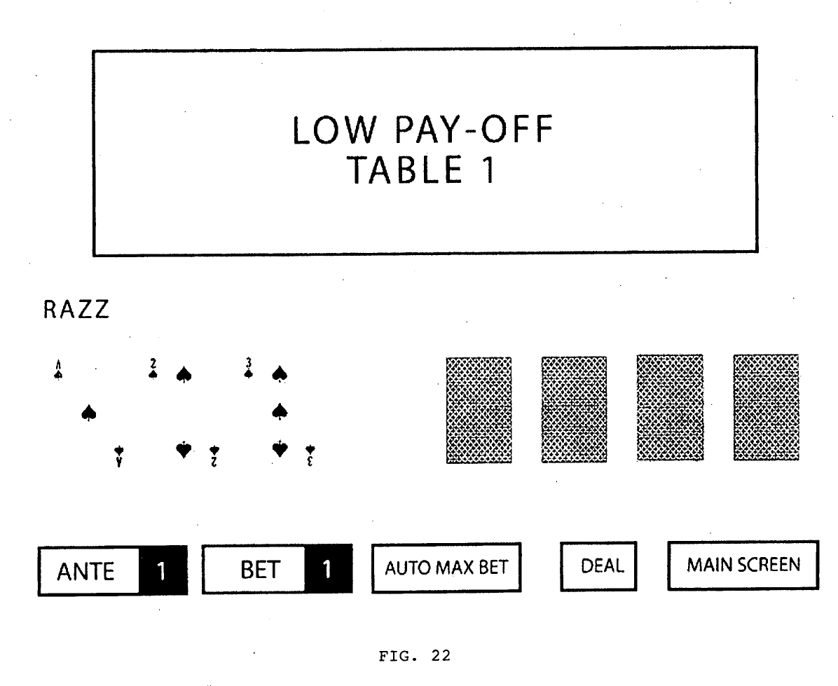

If the player selects the R from the main screen of FIG. 2, the screen for RAZZ, as shown in FIG. 20 appears. Similarly to the other games the player selects ante, bet and auto max. If after making an ante, the player selects deal the screen at FIG. 21 in which the three card Razz appears together with the fold and play options. At this point the player can either fold or elect to play. If the player selects fold, the player loses the ante. If the player selects play, the player may increase his bet and press deal at FIG. 22 and four more cards are dealt, one at a time. The name of the low hand appears above the board and the hand is paid for the total of the ante and the bet according to the pay-off table. Ante, bet, deal and main screen options appear at the end of the hand. If the player desires to play another or different poker game, the player can select main screen and the display will return to FIG. 2. If the player desires to play STUD, the player selects S at the screen of FIG. 2.

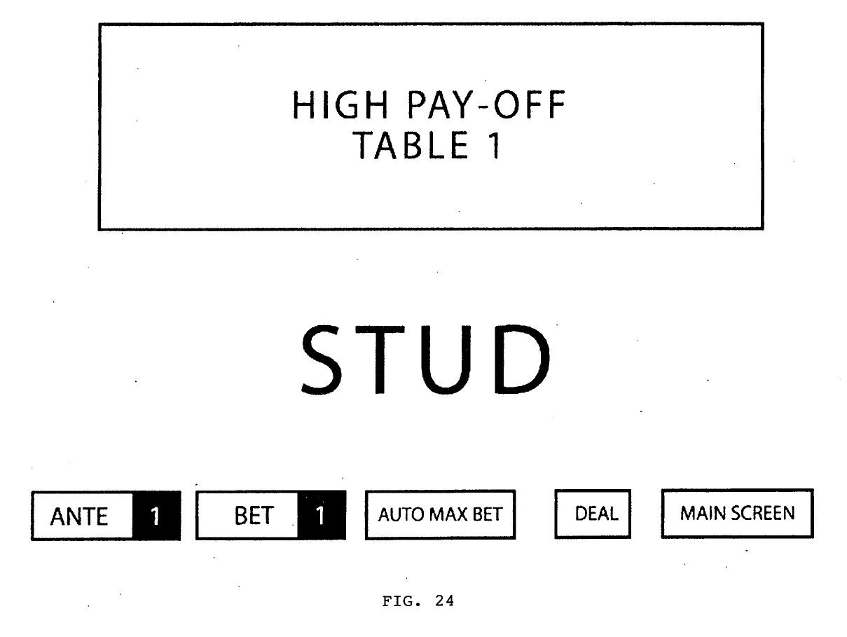

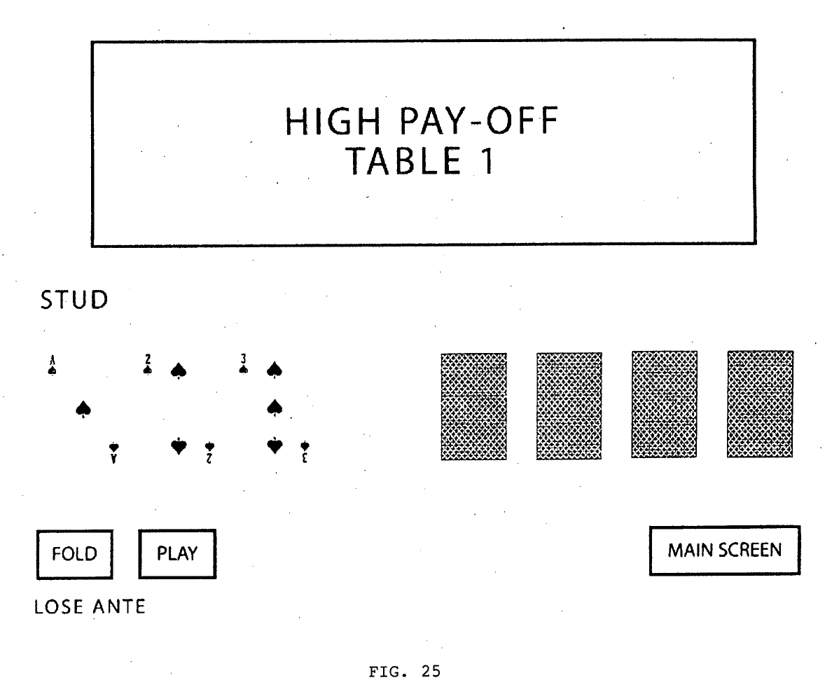

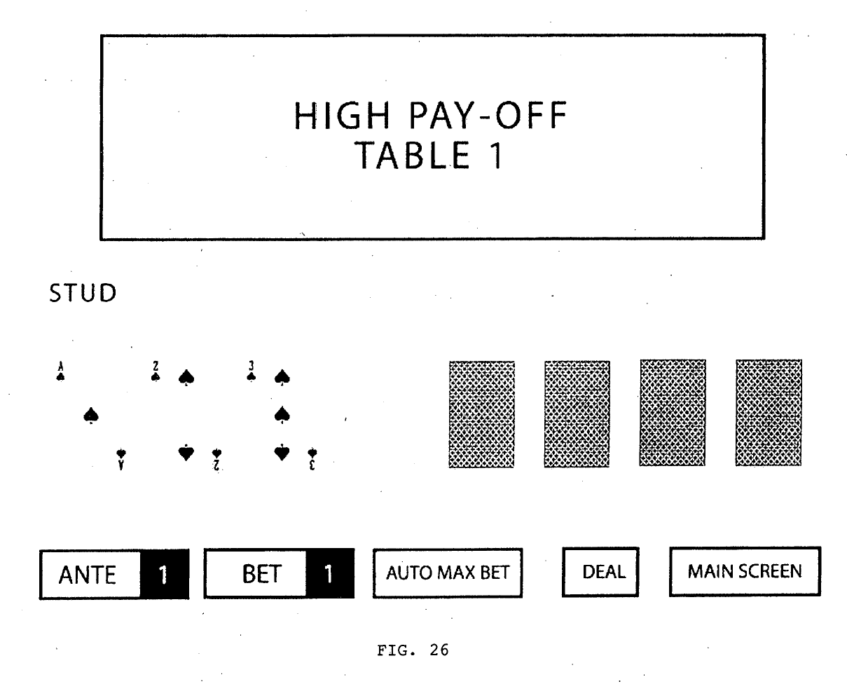

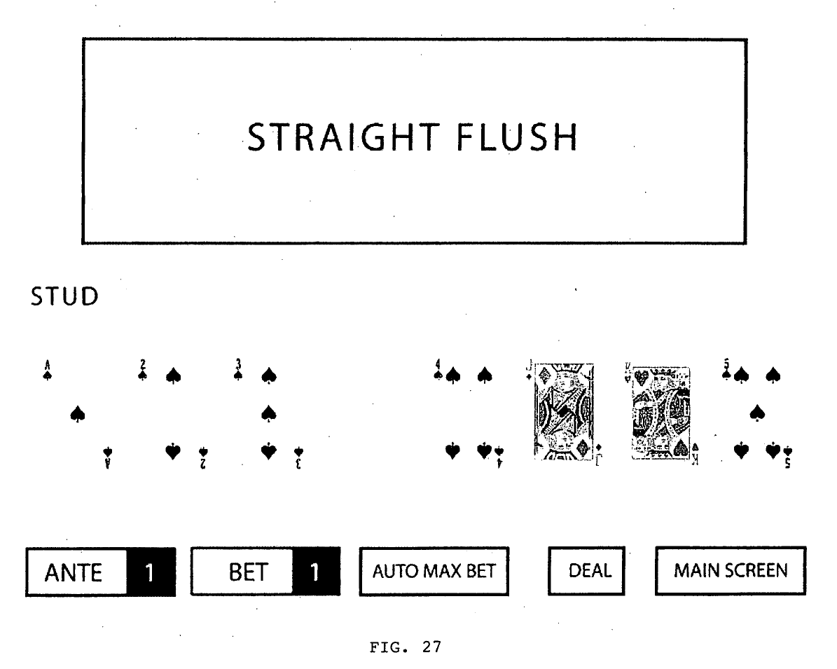

If the player selects S, the screen as shown in FIG. 24 appears and the player can select the ante, bet, auto max and deal options as have been previously described in conjunction with the other poker games. Upon the selection of ante and deal, the game proceeds and the display as in FIG. 25 appears. As is shown in FIG. 25, the three card STUD hand appears with the fold and play options. If the player selects fold, he loses the ante and the game ends as is shown in the FIG. 26 and the player can select to continue to play by anteing and pressing deal or can press main screen, return to the screen of FIG. 2 and change to a different poker game. If the player selects play, four more cards are dealt one at a time as is shown in FIG. 27. The name of the winning had appears above the board for the high hand and the low hand. If there is a winner but no qualifier for either the high and/or the low, NO HIGH and/or NO LOW appears. The hand is paid for, the total of the ante and the bet according to the pay-off tables. Again ante, bet, deal and main screen options appear at the end of the hand and if the player desires to play another or different poker game, the player selects main screen and returns to the main screen shown in FIG. 2. If the new or different poker game selected is Eight or better Stud, the player selects E at the screen of FIG. 2.

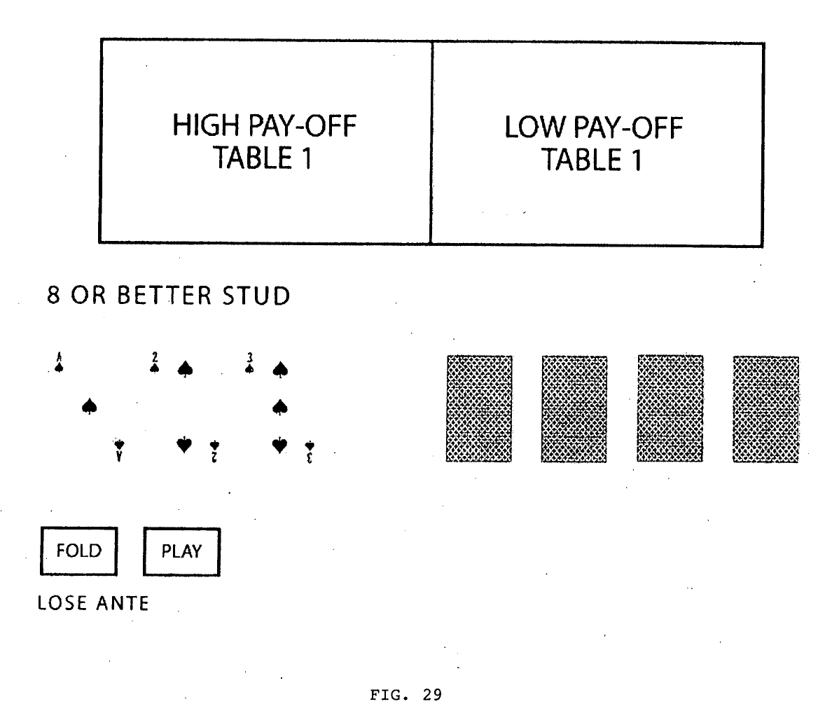

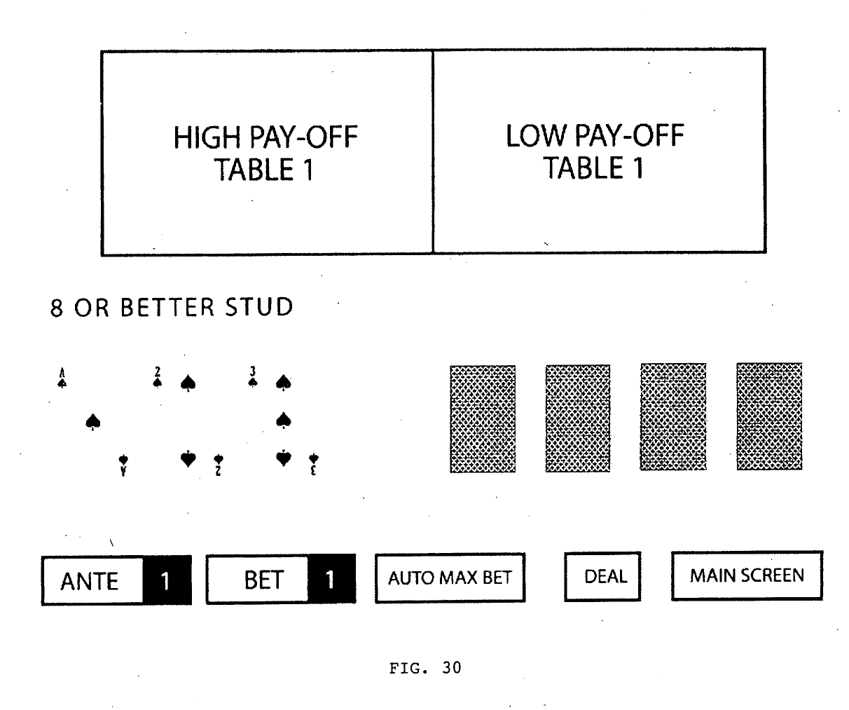

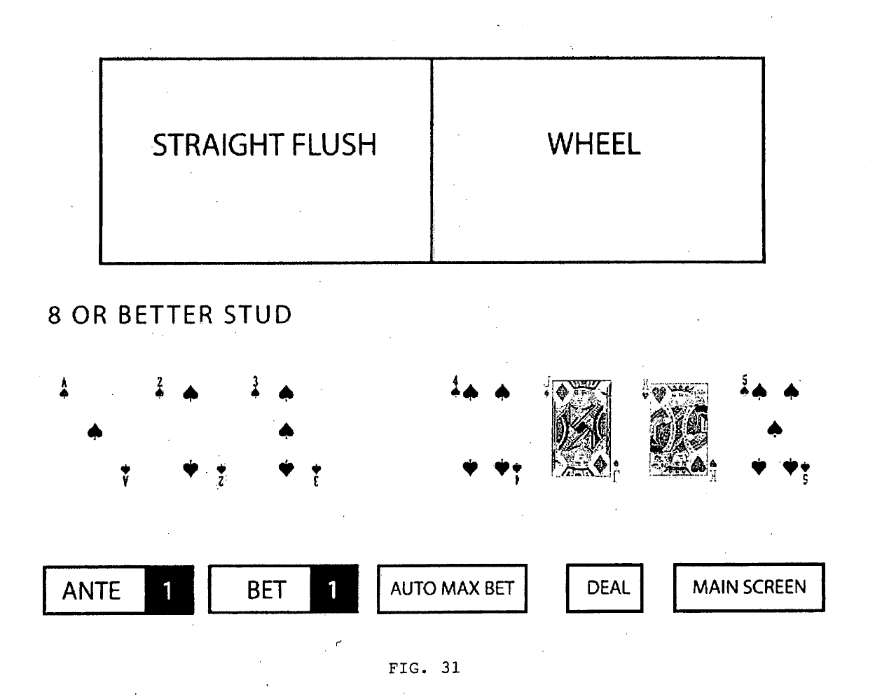

If the player selects E, the ante, bet, auto bet, deal and main screen options will appear and function substantially the same as described previously. If the player decides to play, he selects the ante and deal and the three card Eight or better hand appears with the fold and play options, as is shown in FIG. 29. If the player decides to fold, he selects fold and loses the ante. If the player desires to play, he selects play and the screen as shown in FIG. 30 appears and the player can bet more or deal. If the player selects deal, four more cards are dealt, one at a time, as is shown in FIG. 31. The name of the winning hand appears above the board for the high hand and the low hand. If there is a winner but no qualifier for either the high and/or low, NO HIGH and/or NO LOW will appear. The hand is paid for the total of the ante and the bet according to the pay-off tables. Ante, bet, deal and main screen options appear at the end of the hand and the player can make a selection in substantially the same way as is made with all the other hands.

It should be apparent to those skilled in the art that the hardware making up the apparatus can be assembled by one of ordinary skill in the art, based upon Applicant's disclosure. In addition, based upon Applicant's disclosure, one of ordinary skill in the art can create the software required to run the apparatus. In addition, it should be apparent that other poker games could be programmed into the apparatus and the screens changed to reflect this. Also, while the selection of the modes such as ante, bet, auto max bet, deal and main screen have been discussed in terms of a touch screen, it would also be possible to use other means such as push buttons switches, without departing from the spirit and intent of the invention.

1: A method for playing a plurality of different video poker games using a microprocessor, player input means and a display means comprising the ordered steps of:
displaying a plurality of different poker games on the display means;
selecting one of said plurality of different poker games by means of said player input means; and
playing the selected one of the plurality of different poker games using the display and player input means.

2: A method for playing a plurality of different video poker games wherein the different poker games comprise Hold-em, Omaha Eight or better, Razz, Stud, and Eight or better Stud.

3: An apparatus for playing a plurality of different video poker games comprising:
a display means;
a player input means; and
a control means, said control means for controlling said apparatus such that a plurality of different poker games are displayed on said display means, one of said plurality of different video poker games is selected using said player input means and said selected one of said plurality of different video poker games selected is played by being displayed on said display means and operated by a player by means of said player input means.

4: An apparatus according to claim 3 wherein said control means comprises a microprocessor means and a memory means.

5: The apparatus according to claim 4 wherein said plurality of different video poker games comprises:
a display means;
a player input means; and
a control means, said control means for controlling said apparatus such that a plurality of different poker games are displayed on said display means, one of said plurality of different video poker games is selected using said player input means and said selected one of said plurality of different video poker games selected is played by being displayed on said display means and operated by a player by means of said player input means.
